(19) United States
(12) Patent Application Publication
(10) Pub. No.: US 2009/0121578 A1
(43) Pub. Date: May 14, 2009

(54) BRUSH SYSTEM FOR AN ELECTRIC ACTUATOR

(76) Inventor: Matthias Benkert, Wurzburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/910,480

(22) PCT Filed: Mar. 29, 2006
(86) PCT No.: PCT/EP06/61147

§ 371 Date: Oct. 2, 2007

(30) Foreign Application Priority Data
Apr. 6, 2005 (EP) 05007575.3

(51) Int. Cl. H02K 11/00; H01R 39/38

(52) U.S. Cl. 310/239; 310/71

(57) ABSTRACT

An assembly of a brush system (3) can be simplified by at least one mechanical contact element (33) for providing an external interface. The external interface electrically connects the brush system (3) to a connecting element (4) outside the brush system (3), for example a printed circuit. Provision of the external interface on the brush system (3) allows to assemble the electric actuator (1) in separate assembly steps.

### CROSS-REFERENCE TO RELATED APPLICATIONS

This application is a U.S. national stage application of International Application No. PCT/EP2006/061147 filed Mar. 29, 2006, which designates the United States of America, and claims priority to European application number 05007575 filed Apr. 6, 2005, the contents of which are hereby incorporated by reference in their entirety.

### TECHNICAL FIELD

The invention relates to a brush system for an electric actuator with a base and a number of brushes accommodated in the base and by means of which commutator lamellae of the electric actuator are contactable. In addition, the invention relates to an electric actuator with such a brush system as well as to a method for assembling an electric actuator.

### BACKGROUND

Such actuators are used for example in motor vehicles as drives for sunroofs, window lifters, seat adjusters, seat belt tensioners or the like. They are to be developed as compactly as possible due to the frequently only small fitment area that is available and they should be economical to produce. In the case of solutions known from the prior art, the brush system is first of all soldered onto a printed circuit board. The printed circuit board is subsequently assembled with the brush system in a radial manner to the motor axis. This is not only a process that requires a comparatively large amount of effort, but vibrations on the brush system can also be transferred to the printed circuit board, which can lead to a failure in the control electronics.

### SUMMARY

According to an embodiment, a brush system for an electric actuator that can be easily assembled may comprise a base and a number of brushes accommodated in the base and by means of which commutator lamellae of the electric actuator are contacted, and one mechanical contact element for providing an external interface for an electrical connection between the brushes and a connecting element.

According to another embodiment a method for assembling an electric actuator with a motor, a connecting element and a brush system with a base and a number of brushes accommodated in the base, may comprise the steps of contacting commutator lamellae of the electric actuator with the brushes; providing an external interface for an electrical connection between the brushes and a connecting element with one mechanical contact element; wherein the assembly of the brush system takes place independent of assembling the connecting element.

According to a further embodiment, at least one mechanical contact element may be configured in such a way that the electrical connection is established by forming an interference-fit and/or close-fit connection. According to a further embodiment, the interference-fit and/or close-fit connection may be unlockable. According to a further embodiment, the electrical connection may be a plug-type connector. According to a further embodiment, at least one mechanical contact element may be uncoupled from vibrations via at least one damping element from the base. According to a further embodiment, at least one mechanical contact element may be uncoupled from vibrations via an electrical connecting element from the remaining electrical components of the brush system. According to a further embodiment, the electric actuator may comprise a motor, the connecting element and the brush system, wherein the connecting element can be connected to the brush system via an external interface of the brush system. According to a further embodiment, the connecting element can be a printed circuit board. According to a further embodiment, the connecting element can be a punched grid or the like. According to a further embodiment, the base of the brush system can be uncoupled from vibrations from the connecting element via at least one damping element.

### BRIEF DESCRIPTION OF THE DRAWINGS

The invention is described in more detail below with reference to an exemplary embodiment specified in the associated figures of the drawings. They are as follows:

FIG. 1 an exploded diagram of a section through an electric actuator,

FIG. 2 an exploded diagram of an electric actuator in a perspective view,

FIG. 3 a section through an electric actuator in the assembled state,

FIG. 4 a top view of an electric actuator without a cover,

FIG. 5 a detailed view of an external interface,

FIG. 6 a detailed view of a further external interface.

In the figures in the drawings, the same reference characters refer to the same or functionally comparable components unless stated otherwise.

### DETAILED DESCRIPTION

According to an embodiment, a brush system is proposed, which is characterized by at least one mechanical contact element for providing an external interface. Said external interface electrically connects the brush system to a connecting element outside the brush system, for example a printed circuit board. Provision of the external interface on the brush system allows the electric actuator to be assembled independently of the connecting element. In other words, the assembly of the electric actuator can be carried out in separate assembly steps. In this way, the external interface can be used as a customer interface. The electric actuator can be made available already pre-mounted. At a later point in time, in accordance with the requirements of the respective application, an appropriate connecting element is then connected to the external interface and the electric actuator is thus fully assembled.

A further advantage is that the brush system does not have to be connected in advance with the connecting element. Especially if said connecting element involves a printed circuit board, this process has always required a lot of effort, since the brush system involves a comparatively large component by the standards of electronics manufacturing.

A further advantage of uncoupling the brush system and the connecting element is that the brush system by comparison with solutions known from the prior art can be placed in an even more accurate manner in relation to the motor shaft. The structure of the external interface in particular can compensate for radial tolerances between the brush system and the connecting element.

In addition, the brush system can be introduced to a commutator in the actuator fastened in a radial direction to the drive shaft. This makes possible a very compact embodiment of the electric actuator, a simple embodiment of the housing and a simplified assembly of a brush system with the production of the actuator.

In addition, due to the modular design, an effective vibration uncoupling between the brush system and the connecting element can be achieved so that a transfer of the vibrations to the connecting element can be greatly reduced. For this reason, it is possible to make many parts of inexpensive preferably injection-molded plastic material, in spite of the fact that these plastic parts can generally transfer vibrations really well. Due to the uncoupling, the vibrations of the electric actuator otherwise arising during operation can be greatly reduced and the associated noises strongly reduced or avoided completely. This makes possible a marked increase in user comfort, in particular when using the actuator in a motor vehicle.

In particular the external interface is formed in such a way that said external interface establishes an electrical connection to the connecting element forming an interference-fit and/or close-fit connection. Since in other words, a coherent bond such as for example welding, soldering, adhesion or the like is not necessary for the assembly of the electric actuator, the handling of such a brush system is particularly simple. A particularly safer and nevertheless constructionally simple electrical contacting can be made by using a plug-type connector. However, over and above that, other interference-fit and/or close-fit connections can also be used, such as for example latching connections, snap-in connections and other tongue-and-groove or wedge connections. The use of a bolt connection is also possible. If the interference-fit and/or close-fit connection is implemented in such a way that it can become undone, then the advantages of the modular structure can also be used when exchanging the component. In cases of maintenance or errors, the brush system and the connecting element can be changed independently from one another.

It is particularly advantageous for the transfer of vibrations from the brush system to the connecting element to be reduced. For this purpose, in particular the vibrations, which result from the wiping of the brushes over the commutator lamellae when the actuator is running are attenuated. This may be preferably done by using a damping element located between the base of the brush system and the connecting element and/or between the mechanical contact element and the base of the brush system. In addition, the electrical connection between the mechanical contact element and the other electrical components of the brush system (throttle, brush) can also be decoupled from vibrations by means of a corresponding connecting element.

A printed circuit board should preferably be used as the connecting element. On said board, electrical or electronic components can be provided for actuator control, for example, a microcontroller. If control electronics is not necessary, for example because control functions requiring a lot of effort do not have to be made available for the actuator, the connecting element can also preferably be embodied as an extrusion-coated punched grid or the like. In other words, the connecting element is then configured as a simple electrical contact or as an electrical contact with an on/off switch. A plug-type connector may be preferably provided on the connecting element which is used for the connection of a customer-specific wiring harness or the like. As an alternative, the connecting element is already designed as a connection plug.

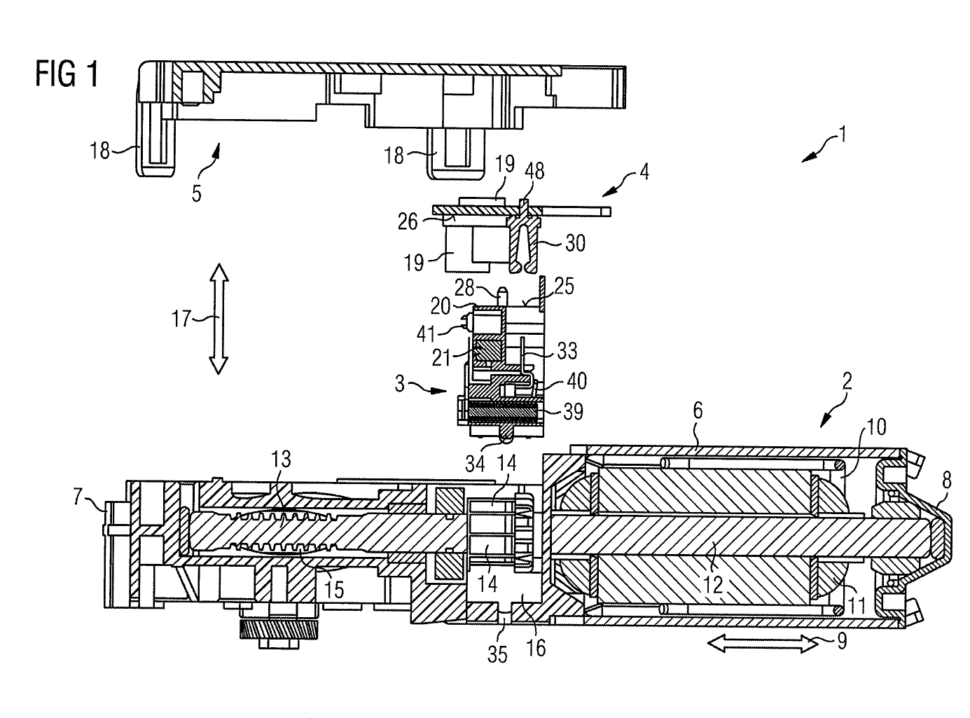

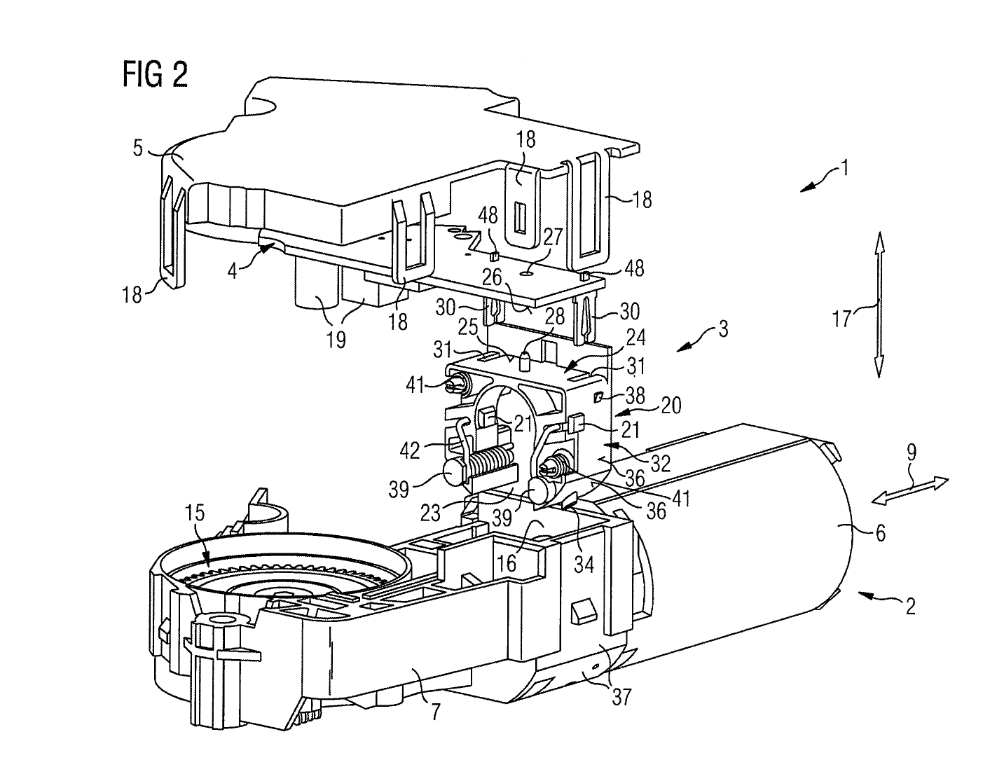

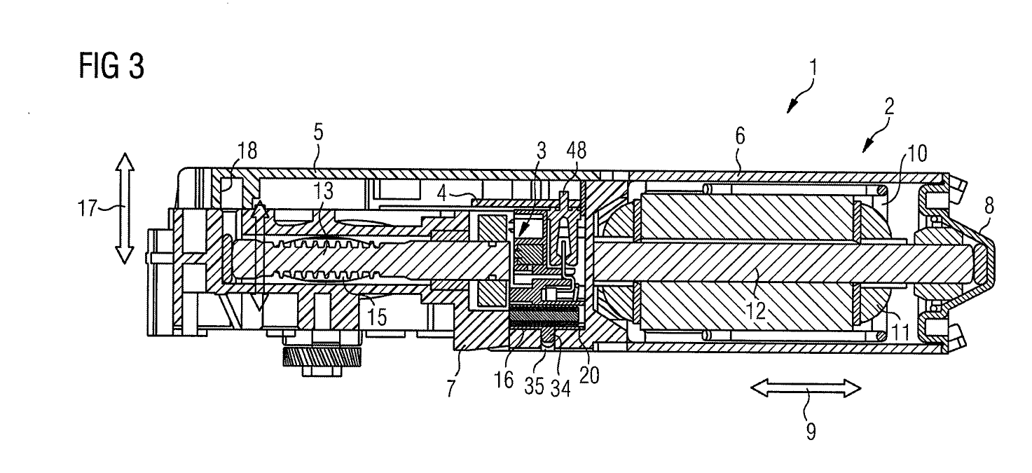

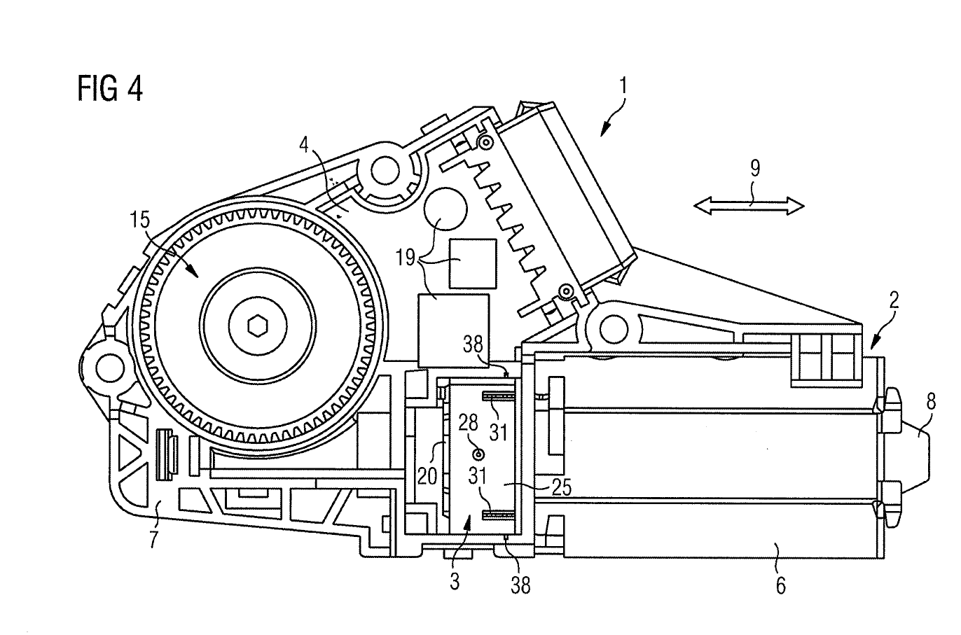

The electric actuator 1 shown in FIGS. 1 to 4 essentially consists of a motor subassembly 2, a brush system 3, an electrical printed circuit board 4 as well as a cover 5. The motor subassembly 2 comprises a motor housing 6, to which a transmission case 7 is fitted. The motor housing 6 is provided with a motor housing cover 8 at its ends.

The transmission case 7 accommodates a transmission 15. The motor housing 6 is configured in such a way that a motor can be introduced in an axial direction 9. The motor can be preferably a permanently excited direct current motor. Permanent magnets 10 are arranged in the motor housing 6 serving as a pole housing. Furthermore the motor has an armature 11, which is provided with coils. The armature in addition comprises an armature shaft 12, which is coupled to a screw 13 or configured as one piece with this. The screw 13 engages into the worm gear of a transmission. In addition, a commutator with commutator lamellae 14 is arranged on the armature shaft 12. The commutator lamellae 14 are electrically connected to correspondingly assigned coils of the armature.

On the input side of the motor turned facing the transmission, an accommodating chamber 16 intended for the brush system 3 is provided as part of the transmission case 7.

For the assembly of the actuator 1, the brush system 3 is introduced, in a radial direction 17, into the accommodating chamber 16 of the motor subassembly 2 which is already in the fully assembled state, thus in a radial direction to the armature shaft 12. Subsequently, the motor subassembly (with or without an installed cover) which is now in the fully assembled state can for example be transported to a user. To this end, the external interface made available in the brush system 3 for a connection to the printed circuit board 4 is thus used. In this process, the printed circuit board 4, is placed onto the brush system 3 in a radial direction 17 as described in detail further below. The cover 5 serves to lock the transmission case 7 after the assembly of the brush system 3 and the printed circuit board 4 and for this purpose has locking elements 18 in the form of sprung latching hooks or snap hooks.

The electrical printed circuit board 4 serving as a connecting element is coupled by means of a socket (not shown) for the connection to a customer-specific wiring harness. The printed circuit board 4 serves as the basis for an electronic circuit for the controlling of the actuator 1 and is, for this purpose, equipped with a number of electrical and electronic components 19.

The brush system 3 which separate from and can be handled independently of the printed circuit board 4 essentially consists of a base 20 and of brushes 21 provided in corresponding brush chambers. The base 20 of the brush system 3 has a U-shaped recess 23 for positioning at the commutator. Furthermore, a bearing surface 25 is provided on the outside of the U-base 24 by means of which the base 20 rests upon the printed circuit board 4 if it is connected to this. Within the region of the bearing surface 26 of the printed circuit board 4 provided for supporting the base 3, this features a bore 27, through which a retaining spigot and a centering pin 28 can be introduced, which extends from the bearing surface 25 of the base 20.

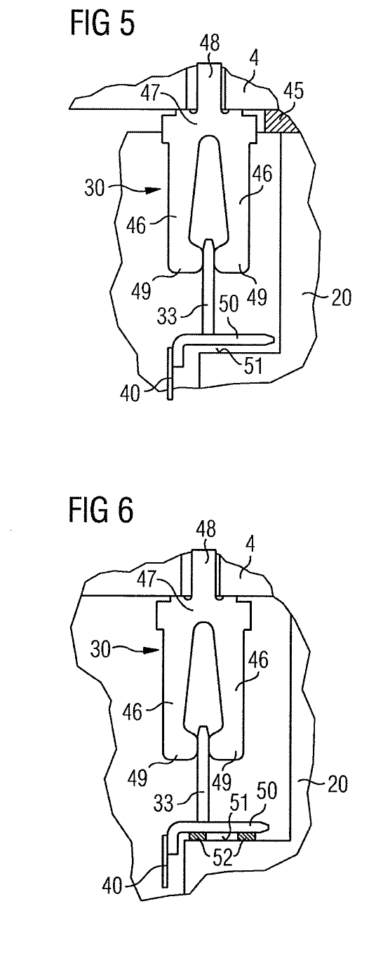

The electrical contacting between the printed circuit board 4 and the brush system 3 is undertaken in particular with the aid of two contact tongues 30 fastened and soldered to the printed circuit board 4, which can be introduced into corresponding receiving slots 31 in the U-limbs 32 of the base 20 and subsequently make contact with the contact lugs 33 of the brush system 3. A detailed description of the external interface of the brush system 3 configured as a result of this, is given in connection with FIGS. 5 and 6.

Centering pins 34 are arranged at the free ends of the U-limb 32, which on assembly of the brush system 3 are introduced into recesses 35 in the transmission case 7. As a result of this, it is thus guaranteed in a simple way that the U-shaped recess 23 of the base 20 is not squeezed together when assembling. In addition, with the aid of the centering pins 34, the brush system 3 is fixed in an axial direction referred to the armature shaft 12 of the motor in the transmission case 7. At the outer sides of the U-limb 32 on the opposite side of the recess 23, bearing surfaces 36 are configured 36, by means of which the base 20 in the assembled state rests upon the inside of the wall 37 of the transmission case 7. The bearing surfaces 36 ensure an additional centering of the base 20 in the transmission case 7 and thereby guarantee a precise assembly of the brush system 3 in the electric actuator 1. In addition, the brush system 3 is held in position in the accommodating chamber 16 by means of locking elements 38, which are arranged on the bearing surfaces 36 and interact with corresponding (not shown) locking elements on the inside of the wall 37.

The base 20 features receptacles for electrical throttles 39. Said throttles 39, in the assembled state of the brush system 3 are electrically connected to the printed circuit board 4 by means of corresponding connections. The connection is made via the contact lugs 33 of the brush system 3 and the contact tongues 30 of the printed circuit board 4. In this process, the throttles 39 are connected to the contact lugs 33 of the brush system 3 by means of flexible throttle lines 40.

In the fully assembled state of the brush system 3 in the actuator 1, the brushes 21 arranged in the brush chambers are in each case pressed by means of a leg spring 41 against the commutator lamellae 14 of the commutator. The brushes 21 can be preferably electrically connected to the throttles 39 by means of a flexible braided wire 42. On the base 20, dome-type spring retainers are configured for the leg springs 41.

The assembly position of the brushes 21 is advantageously given in such a way that the brushes 21, at a predetermined distance to the commutator lamellae 14, are locked if the brush system 3 is introduced into the transmission case 7. In this way it can be guaranteed in a simple way that the brush system 3 can be introduced in a radial direction to the armature shaft 12 into the transmission case 7 if the armature shaft 12 is already in the motor housing 6. For the completion of the assembly, the locking of the brushes is released so that they are pressed against the commutator lamellae 14 of the commutator by means of the leg springs 41.

For absorbing vibrations, an uncoupling element 45 is arranged between the base 20 of the brush system 3 and the printed circuit board 4, cf. FIG. 5. This uncoupling or damping element 45 may preferably consist of an elastomer. However, it can also be made of other materials with appropriate elasticity and absorption characteristics, such as for example NBR, Si-elastomers or polyurethane.

The frequency of the vibrations, which is produced by the transition of the brushes from one commutator lamella 14 to the next commutator lamella 14, are dependent on the number of revolutions of the motor and thus on the number of revolutions of the commutator lamellae 14. If the motor has a number of revolutions of 5000 revolutions per minute and depending on the load is operated with 3000 to 5000 revolutions per minute and has a commutator with ten commutator lamellae 14, then the frequency of the vibrations is between 500 and 1000 Hz.

Within this context, the uncoupling of vibrations means that vibrations, which are due to the sharpening of the brushes 21 over the commutator lamellae 14 of the commutator are strongly absorbed. The amplitude of these vibrations is absorbed for example at least around the region of 30%.

Likewise, the contact tongues 30 connected to the printed circuit board 4 may be in the same way as the contact lugs 33 of the brush system 3 preferably made of a springy contact plate. In this process, the contact tongue 30 essentially configured in a U-shaped way, has two contact arms 46 as the U-limb, which on the basis of the connection basis 47 serving as the U-base essentially extend in a perpendicular manner from the printed circuit board 4. The connection basis 47 has a contact pin 48, which is soldered to the printed circuit board 4. The contact arms 46, on their free ends exhibit contact fingers 49 facing each other, which when contacting the contact lug 33 become unbent and according to the type of tongue, clamp the contact lug 33 between itself and a plug-type connector that can become undone is configured in this way. The panel-shaped contact lug 33 which essentially is to extend in a perpendicular manner to the printed circuit board 4 in the assembled state of the brush system 3, is in other words in the region of its free ends reciprocally contacted so that a particularly safe electrical connection is given. This is connected to a carrier element 50 in the foot region of the contact lug 33, which in the not attached state remains in constant contact with and rests upon a storage surface 51 of the base 20 which has been made available for this purpose.

During the contacting of the contact tongue 30 and the contact lug 33, the carrier element 50 is easily taken off from the base 20 of the brush system 3 by reshaping the uncoupling element 45 so that a direct mechanical coupling of the contact lug 33 with the base 20 no longer exists. The throttle line 40 connected to the carrier element 50 preferably may consist of a large number of smaller more thinly and non-insulated braided wires, which do not transfer impact sound. The throttle line 40 is fastened in such a way to the carrier element 50, for example, soldered on or welded to said carrier element that it serves as a flexible and mobile connecting element for an uncoupling of vibrations.

However, in addition to the uncoupling element 45 arranged between the base 20 and the printed circuit board 4 or as an exclusive uncoupling element of the brush system 3, a number of uncoupling elements or damping elements 52 arranged between the base 20 and the contact lug 33 or the carrier element 50 can also be used in the same way as they are exemplary represented in FIG. 6.

Via further uncoupling elements or damping elements (not shown), a mechanical uncoupling of the brush system 3 and the transmission case 7 can also take place. These additional damping elements may preferably be arranged directly on the base 20 of the brush system 3.

The use of uncoupling elements or damping elements is used for uncoupling of vibrations from the motor subassembly 2 and the brush system 3 or the brush system 3 and the printed circuit board 4. Due to the precise seat of the brush system 3 in the transmission case 7 and the uncoupling of vibrations, said vibrations and noise emissions can strongly be reduced.

What is claimed is:

1. A brush system for an electric actuator, comprising a base and a number of brushes accommodated in the base and by means of which commutator lamellae of the electric actuator are contacted, and one mechanical contact element for providing an external interface for an electrical connection between the brushes and a connecting element.

2. The brush system according to claim 1, wherein at least one mechanical contact element is configured in such a way that the electrical connection is established by forming an interference-fit and/or close-fit connection.

3. The brush system according to claim 2, wherein the interference-fit and/or close-fit connection is unlockable.

4. The brush system according to claim 1, wherein the electrical connection is a plug-type connector.

5. The brush system according to claim 1, wherein at least one mechanical contact element is uncoupled from vibrations via at least one damping element from the base.

6. The brush system according to claim 1, wherein at least one mechanical contact element is uncoupled from vibrations via an electrical connecting element from the remaining electrical components of the brush system.

7. The brush system according to claim 1, wherein the electric actuator comprises a motor, the connecting element and the brush system wherein the connecting element is connected to the brush system via an external interface of the brush system.

8. The brush system according to claim 7, wherein the connecting element is a printed circuit board.

9. The brush system according to claim 7, wherein the connecting element is a punched grid or the like.

10. The brush system according to claim 7, wherein the base of the brush system is uncoupled from vibrations from the connecting element via at least one damping element.

11. A method for assembling an electric actuator with a motor, a connecting element and a brush system with a base and a number of brushes accommodated in the base, the method comprising the steps of:
contacting commutator lamellae of the electric actuator with the brushes;
providing an external interface for an electrical connection between the brushes and a connecting element with one mechanical contact element;
wherein the assembly of the brush system takes place independent of assembling the connecting element.

12. The method according to claim 11, wherein at least one mechanical contact element is configured in such a way that the electrical connection is established by forming an interference-fit and/or close-fit connection.

13. The method according to claim 12, wherein the interference-fit and/or close-fit connection is unlockable.

14. The method according to claim 11, wherein the electrical connection is a plug-type connector.

15. The method according to claim 11, wherein at least one mechanical contact element is uncoupled from vibrations via at least one damping element from the base.

16. The method according to claim 11, wherein at least one mechanical contact element is uncoupled from vibrations via an electrical connecting element from the remaining electrical components of the brush system.

17. The method according to claim 11, wherein the electric actuator comprises a motor, the connecting element and the brush system, wherein the connecting element is connected to the brush system via an external interface of the brush system.

18. The method according to claim 17, wherein the connecting element is a printed circuit board.

19. The method according to claim 17, wherein the connecting element is a punched grid or the like.

20. The method according to claim 17, wherein the base of the brush system is uncoupled from vibrations from the connecting element via at least one damping element.
